(19) United States
(12) Patent Application Publication
(10) Pub. No.: US 2026/0038185 A1
(43) Pub. Date: Feb. 5, 2026

(54) METHOD, APPARATUS, DEVICE AND MEDIUM FOR DRAWING AN EFFECT IMAGE

(71) Applicant: Beijing Zitiao Network Technology Co., Ltd., Beijing (CN)

(72) Inventor: Qi Yuan, Beijing (CN)

(21) Appl. No.: 18/996,607

(22) PCT Filed: Sep. 6, 2023
(86) PCT No.: PCT/CN2023/117329

§ 371 Date: Jan. 17, 2025

(30) Foreign Application Priority Data
Sep. 8, 2022 (CN) 202211098070.6

(51) Int. Cl. G06T 15/04; G06T 5/70; G06T 7/20; G06T 17/20; G06V 20/40

(52) U.S. Cl. CPC G06T 15/04; G06T 5/70; G06T 7/20; G06T 17/20; G06V 20/40; G06T 2207/10016; G06T 2207/20221; G06T 2207/30241; G06V 2201/07

(57) ABSTRACT

The embodiment of the disclosure provides a method, an apparatus, a device, and a medium for drawing an effect image. The method includes: in response to an effect drawing request triggered by a user, performing trajectory tracking on a target video provided by the user to obtain a three-dimensional point set corresponding to a motion trajectory of a target object in the target video; performing a meshing processing on the three-dimensional point set to obtain a target mesh structure; performing a map processing on the target mesh structure to obtain a target effect image; and displaying, in the target video, the target effect image corresponding to the motion trajectory of the target object. According to the technical solution, the effect image is generated with the three-dimensional point set to obtain stereo effect image, thus the display performance of the effect image is improved.

### CROSS-REFERENCE OF RELATED APPLICATIONS

This application claims priority to Chinese Patent Application No. 202211098070.6, filed on Sep. 8, 2022, and entitled “METHOD, APPARATUS, DEVICE AND MEDIUM FOR DRAWING AN EFFECT IMAGE”, the entire contents of which are incorporated herein by reference.

### FIELD

The embodiment of the disclosure relates to the technical field of computers, in particular to a method, an apparatus, a device, and a medium for drawing an effect image.

### BACKGROUND

At present, effects may be displayed to a user in the fields of augmented reality (AR) virtual interaction, short video play, and the like. For example, in a process of playing a video by a user, a pre-generated effect image, for example, an effect scene such as a flower and a rocket, may be added to a face in the video.

### SUMMARY

In a first aspect, an embodiment of the present disclosure provides a method for drawing an effect image, comprising:
in response to an effect drawing request triggered by a user, performing trajectory tracking on a target video provided by the user to obtain a three-dimensional point set corresponding to a motion trajectory of a target object in the target video;
performing a meshing processing on the three-dimensional point set to obtain a target mesh structure;
performing a map processing on the target mesh structure to obtain a target effect image; and
displaying, in the target video, the target effect image corresponding to the motion trajectory of the target object.

In a second aspect, an embodiment of the present disclosure provides an apparatus for drawing an effect image, comprising:
a trajectory tracking unit configured to, in response to an effect drawing request triggered by a user, perform trajectory tracking on a target video provided by the user, to obtain a three-dimensional point set corresponding to a motion trajectory of a target object in the target video;
a mesh generation unit configured to perform a meshing processing on the three-dimensional point set to obtain a target mesh structure;
an effect generation unit configured to perform a map processing on the target mesh structure to obtain a target effect image; and
an effect display unit configured to display, in the target video, the target effect image corresponding to the motion trajectory of the target object.

In a third aspect, an embodiment of the present disclosure provides an electronic device, comprising: a processor, a memory, and an output device;
the memory storing computer executable instructions;
the processor executing the computer executable instructions stored in the memory, to cause the processor to be configured with the method for drawing an effect image according to the above first aspect and various possible designs thereof, and the output device being configured to output a target video having a target effect image.

In a fourth aspect, an embodiment of the present disclosure provides a computer readable storage medium storing computer executable instructions that, when executed by a processor, implement the method for drawing an effect image according to the above first aspect and various possible designs thereof.

In a fifth aspect, an embodiment of the present disclosure provides a computer program, a computer program, when executed by a processor, implements the method for drawing an effect image according to the above first aspect and various possible designs thereof.

In a sixth aspect, an embodiment of the present disclosure provides a computer program product, comprising a computer program that, when executed by a processor, implements the method for drawing an effect image according to the above first aspect and various possible designs thereof.

According to the technical scheme provided by the disclosure, a corresponding target video is obtained through interaction with the user. A trajectory tracking is performed on the target video to obtain a three-dimensional point set corresponding to a motion trajectory of a target object in the target video. On the three-dimensional point set, a meshing processing is performed to obtain a target mesh structure. After the target mesh structure is obtained, a map processing is performed on the target mesh structure to obtain a target effect image. Therefore, the target effect image is displayed accordingly on the motion trajectory of the target object, and then the target effect image may be displayed accordingly on the motion trajectory of the video.

### BRIEF DESCRIPTION OF THE DRAWINGS

In order to more clearly illustrate the embodiments of the present disclosure or the technical solutions in the prior art, the accompanying drawings used in the description of the embodiments or the prior art will be briefly introduced below, and it will be apparent that the drawings in the following description are some embodiments of the present disclosure, and those skilled in the art may also obtain other drawings according to these drawings without creative labor.

FIG. 1 is an application example diagram of a method for drawing an effect image according to an embodiment of the present disclosure;

FIG. 2 is a flowchart of a method for drawing an effect image according to an embodiment of the present disclosure;

FIG. 3 is a flowchart of a method for drawing an effect image according to another embodiment of the present disclosure;

FIG. 4 is an example diagram of resampling according to an embodiment of the present disclosure;

FIG. 5 is an example diagram of sampling according to an embodiment of the present disclosure;

FIG. 6 is a flowchart of a method for drawing an effect image according to yet another embodiment of the present disclosure;

FIG. 7 is a schematic diagram of a triangulation of a three-dimensional point set according to an embodiment of the present disclosure;

FIG. 8 is a flowchart of a method for drawing an effect image according to yet another embodiment of the present disclosure;

FIG. 9 is an example diagram of an annular strip-shaped effect diagram according to an embodiment of the present disclosure;

FIG. 10 is a schematic structural diagram of an apparatus for drawing an effect image according to an embodiment of the present disclosure;

FIG. 11 is a schematic diagram of a hardware structure of an electronic device according to an embodiment of the present disclosure.

### DETAILED DESCRIPTION

In order to make the objectives, technical solutions and advantages of the embodiments of the present disclosure clearer, the technical solutions in the embodiments of the present disclosure will be clearly and completely described below with reference to the accompanying drawings in the embodiments of the present disclosure. Obviously, the described embodiments are a part of the disclosed embodiments, not all of them. Based on the embodiments disclosed in this disclosure, all other embodiments obtained by ordinary skilled persons in this field without creative labor are within the scope of protection of this disclosure.

The technical scheme of this disclosure may be applied to the AR technical scene. By tracking the trajectory of the target object in the video and performing mesh processing and mapping processing based on the motion trajectory of the target object, the target effect image is obtained, and the corresponding effect of the trajectory is output, thus the real-time and accuracy of the effect output are improved.

In the related art, in a conventional effect output scene, a pre-generated effect image is generally mixed with an image frame in a video, or an effect image is directly generated for a region of interest such as a human face in an image frame. After the image frame with the effect is generated, the video with the effect may be displayed through output. However, the effect processing in the above manner is that the effect performed on the image frame is increased, which is not relevant to the behavior of the user. The lack of the interaction with the user causes the application scene of the effect image to be limited. Further, real-time interaction between the effect and the user is lacked.

In order to solve the above technical problem, the present disclosure considers the trajectory tracking of the target object in the video, and performs effect generation by using the tracked trajectory to generate a three-dimensional point set for the motion trajectory of the target object in the video. The effect image is generated with the three-dimensional point set, the stereoscopic effect image is obtained, and the display performance of the effect image is improved.

The disclosure relates to the technical field of computer, cloud computing, virtual reality and the like, in particular to a method, an apparatus, a device and a medium for drawing an effect image.

In the technical solution of the present disclosure, the corresponding target video is obtained by interacting with the user. A trajectory tracking is performed on the target video to obtain a three-dimensional point set corresponding to a motion trajectory of a target object in the target video. On the three-dimensional point set, a meshing processing is performed to obtain a target mesh structure. After the target mesh structure is obtained, a map processing is performed on the target mesh structure to obtain a target effect image. Therefore, the target effect image is displayed accordingly on the motion trajectory of the target object, and then the target effect image may be displayed accordingly on the motion trajectory of the video. According to the technical scheme, by tracking the trajectory of the target object in the video, the mesh structure of the effect is generated based on the motion trajectory, the target effect image matched with the user trajectory is obtained, and the effect of the motion behavior of the user is generated, thus the application scene of the effect is expanded, and the use efficiency of the effect is improved.

The following will provide a detailed explanation of the disclosed technical solution and how it solves the aforementioned technical problems through specific embodiments. The following specific embodiments can be combined with each other, in which the same or similar concepts or processes may not be repeated in some embodiments. The following will provide a detailed description of the disclosed embodiments in conjunction with the accompanying drawings.

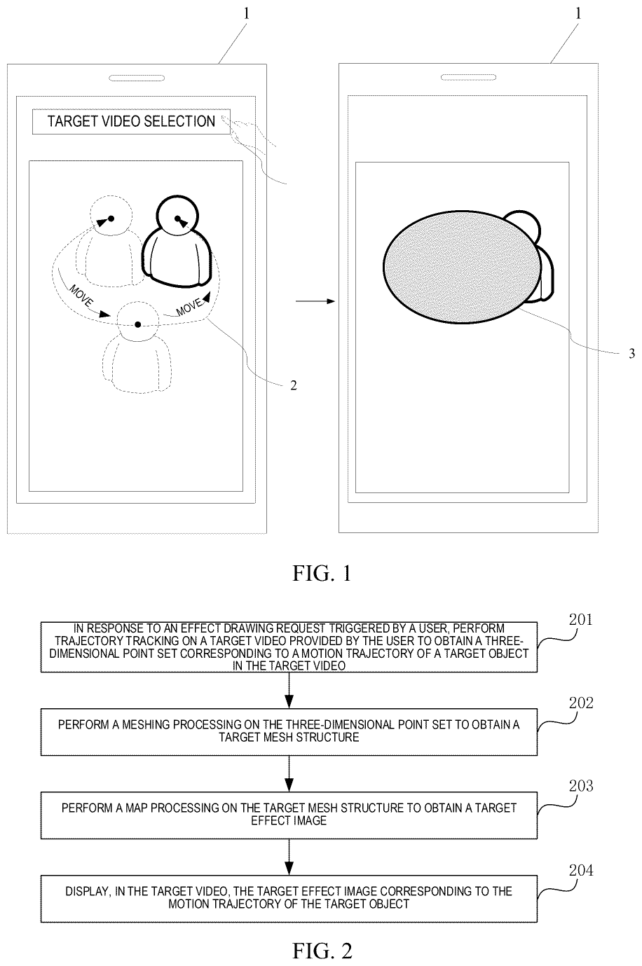

FIG. 1 is an application example diagram of a method for drawing an effect image according to the present disclosure, and the method for drawing an effect image may be applied to the electronic device 1. The electronic device 1 may include, for example, an AR device. The electronic device 1 may detect an effect drawing request triggered by a user. The electronic device 1 may configure the technical solutions of the present disclosure, respond to the effect drawing request, obtain a target effect image, and display an output target effect image corresponding to the motion trajectory of the target object.

For example, assuming that the motion trajectory of the user in the target video is a curve 2, a moon 3 may be generated based on the curve 2. The moon 3 may be output at a curve 2 corresponding to the motion trajectory.

It should be noted that, in the application example shown in FIG. 1, the trajectory of the target object U changes along with the movement of the target object. The target object U may be unchanged in the trajectory tracking process. The plurality of target objects shown in the figures are only for showing the change of the movement trajectory of the target object U, and do not represent a plurality of trajectory objects. Referring to FIG. 1, in the moving process of the target object U, a corresponding motion trajectory may be generated, that is, curve 2.

Referring to FIG. 2, which is a flowchart of a method for drawing an effect image according to an embodiment of the present disclosure. The method may be configured for an apparatus for drawing an effect image, and the apparatus for drawing an effect image may be located in an electronic device. The method for drawing an effect image may include the following steps:

201: in response to an effect drawing request triggered by a user, performing trajectory tracking on a target video provided by the user to obtain a three-dimensional point set corresponding to a motion trajectory of a target object in the target video.

Optionally, the effect drawing request may refer to a Uniform Resource Locator (URL) request for drawing an effect. An effect drawing control may be set on the video playing page, and when it is detected that the user triggers the effect drawing control, the effect drawing request is triggered. The video playing page may refer to a webpage playing the target video. The effect drawing request triggered by the user may be detected in the playing process of the target video. The target video may be a real-time video being played by the electronic device.

The technical solution of the present disclosure may also be applied to a webpage technology, a target video may be played through a webpage, and a target video may be played in a player of a webpage. The webpage may be obtained through a Hypertext Markup Language (HTLM5), Objective-C, Java and other programming languages.

After the effect drawing request is triggered, a selection page or dialog box of the target video may also be provided, through which the target video may be selected. The target video uploaded by the user may be received, and the target video may be received from the user side. In the embodiments of the present disclosure, a specific uploading mode of the target video is not limited. The target video may include a two-dimensional video of a common type, or may include a video played by the AR device.

The target object may include at least one of an object moving in the target object, a vehicle, a pedestrian, a facial feature of a person, and the like. The target object in the tracked process may be any point on the target object. Taking a face as an example, the target object may refer to a key point that is easily recognized in the face, for example, any point such as a forehead center point, a two-eye center, and a nose tip as a key point.

The motion trajectory is generally a curve formed by key points obtained by sampling on an image frame in a video. The obtaining the three-dimensional point set corresponding to the motion trajectory of the target object in the target video may specifically refer to the following: determining the position point of the target object, that is, the key point or the trajectory point, from image frame in which the target object presents of the target video, and forming the motion trajectory from the key points of the plurality of image frames, performing secondary sampling on the motion trajectory, obtaining sampling points with a higher density than the original trajectory points, and determining the three-dimensional point set with the sampling points.

202: performing a meshing processing on the three-dimensional point set to obtain a target mesh structure.

Optionally, the target mesh structure may include a curved mesh structure or an annular strip-shaped mesh structure.

The target mesh structure may be a mesh surface determined according to the three-dimensional point set corresponding to the trajectory, may include a surface of a common planar structure, or may include an annular surface formed by the trajectory contour.

203: performing a map processing on the target mesh structure to obtain a target effect image.

The target mesh structure is not provided with a map. The texture image may be pasted onto the target mesh structure, and the target mesh structure is pasted with the texture image to obtain the target effect image.

The map of the mesh structure may be implemented by map software.

204: displaying, in the target video, the target effect image corresponding to the motion trajectory of the target object.

The target effect image may be displayed at a position corresponding to the motion trajectory of the target object in the target video.

The target effect image may be a three-dimensional image. The target effect image may be displayed by the output device of the electronic device. Specifically, when the electronic device displays the target video, the target effect image is displayed in association with the position of the motion trajectory of the target object. Specifically, the center position of the motion trajectory may be used as the center position of the target effect image, and the target effect image may be displayed at the center position.

The electronic device may include a mobile phone, an AR device, a virtual reality device, and the like, and a specific type of the electronic device in this embodiment is not limited. The electronic device may display a three-dimensional target effect image. Certainly, in actual application, the target effect image may be converted into a two-dimensional effect image and an effect point cloud in a coordinate conversion manner to perform effect display.

In this embodiment, trajectory tracking is performed on the target video to obtain a three-dimensional point set corresponding to the motion trajectory of the target object in the target video. The target mesh structure is obtained by meshing the three-dimensional point set, and the target mesh structure of the motion trajectory can be generated through the generation of the target mesh structure. After the target mesh structure corresponding to the motion trajectory is obtained, a map processing may be performed on the target mesh structure to obtain the target effect image. Therefore, the target effect image is displayed accordingly on the motion trajectory of the target object, and then the target effect image may be displayed accordingly on the motion trajectory of the video. According to the technical scheme, by tracking the trajectory of the target object in the video, the mesh structure of the effect is generated based on the motion trajectory, the target effect image matched with the user trajectory is obtained, and the effect of the motion behavior of the user is generated, thus the application scene of the effect is expanded, and the use efficiency of the effect is improved.

As shown in FIG. 3, which is a flowchart of a method for drawing an effect image according to yet another embodiment of the present disclosure, and is different from the embodiment shown in FIG. 2 in that: the performing trajectory tracking on a target video provided by the user to obtain a three-dimensional target point set corresponding to a motion trajectory of a target object in the target video comprises:

301: recognizing the target object in the target video.

Optionally, a target tracking algorithm may be used to recognize the target object in the target video.

After the target object is recognized, the key points of the target object may be determined. For example, taking a face as the target object, any point in the face may be used as a key point, such as, a nose tip, the center between two eyes, and the like may serve as key points.
302: sampling the motion trajectory of the target object in the target video to obtain at least one target sampling point.
303: mapping the at least one target sampling point to a three-dimensional space coordinate system to obtain the three-dimensional point set.

Mapping the target sampling point to the three-dimensional space coordinate system may include: mapping the target sampling point from the two-dimensional space coordinate system to the three-dimensional space coordinate system.

In the embodiments of the present disclosure, the target object in the target video may be recognized to sample the motion trajectory of the target object, thus to obtain a two-dimensional point set, and the three-dimensional point set is obtained by mapping the two-dimensional point set to the three-dimensional space coordinate system. Accurate extraction of the three-dimensional point set corresponding to the motion trajectory can be realized through trajectory sampling and spatial mapping.

In an embodiment, the sampling the motion trajectory of the target object in the target video to obtain at least one target sampling point comprises:
sampling the motion trajectory of the target object from the target video to obtain a two-dimensional point set, the two-dimensional point set comprising a plurality of first sampling points;
resampling the two-dimensional point set to obtain a plurality of second sampling points; and
determining, from the plurality of second sampling points, at least one target sampling point meeting a trajectory smoothing condition.

Optionally, resampling the two-dimensional point set to obtain the plurality of second sampling points may include: sampling pairwise adjacent sampling points in the plurality of first sampling points in the two-dimensional point set to obtain a second sampling point, and obtaining a plurality of second sampling points at the end of the two-dimensional point set resampling.

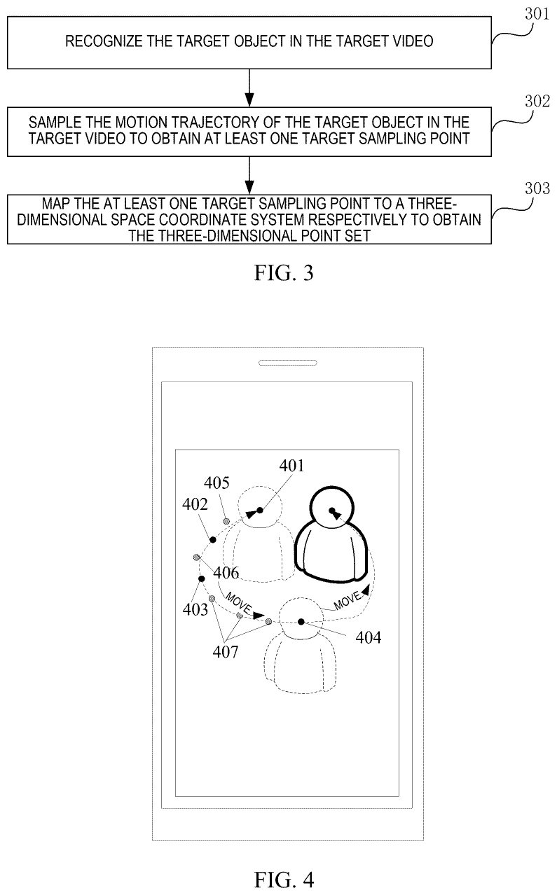

For ease of understanding, as shown in the resampling example diagram in FIG. 4, it is assumed that in the motion trajectory of the target object, the first sampling points collected are 401-404, respectively. Referring to FIG. 4, the distance between two adjacent sampling points is relatively large. If the effect is directly drawn according to the sampling points, a large contour error may occur. In order to avoid this phenomenon, the technical solution of the present disclosure adopts resampling. That is, the fitting curve based on the first sampling point may be segmented, and the segmented curve may be resampled. The sampling points obtained from the resampling are the second sampling points. Referring to FIG. 4, the segmented curve corresponding to the first sampling points 401 and 402 is sampled to obtain the second sampling point 405, the segmented curve corresponding to the first sampling points 402 and 403 is sampled to obtain the second sampling point 406, and the segment curve corresponding to the first sampling points 403 and 404 is sampled to obtain three second sampling points 407. Certainly, the manner of directly performing curve fitting on the adjacent sampling points is merely illustrative, and should not constitute a limitation on the technical solutions of the present disclosure. The segmented curve may also be resampled by using an entire curve fitting and a segmentation manner, which may be specifically described with reference to the following embodiments.

The first sampling point may be a key point obtained by sampling from the target video. The second sampling point may be a sampling point obtained by resampling based on the first sampling point, and the second sampling point may include the first sampling point.

The trajectory smoothing condition may mean that a distance between the sampling point and the trajectory is less than a distance threshold or is located on the trajectory. Through the trajectory smoothing condition, a sampling point with a large difference from the trajectory can be removed, so that the obtained trajectory formed by the at least one target sampling point is smooth, the occurrence of sharp points is avoided, and the trajectory accuracy is improved.

In the embodiment of the disclosure, after the motion trajectory of the target object in the target video is sampled, a two-dimensional point set composed of a plurality of first sampling points is obtained. The two-dimensional point set is resampled to obtain denser second sampling points, and the sampling points are resampled to enhance density. After the second sampling points are obtained, at least one target sampling point meeting the trajectory smoothing condition can be determined from the second sampling points, the second sampling points is optimized by using the trajectory smoothing condition, the trajectory corresponding to the target sampling point is smoother, and the acquisition precision and accuracy of the target sampling point are improved.

In some embodiments, the sampling the motion trajectory of the target object from the target video to obtain a two-dimensional point set comprises:
collecting a trajectory point of the target object from an image frame of the target video according to a predetermined sampling frequency;
determining whether the trajectory point satisfies a distance constraint condition based on a predetermined distance threshold;
if yes, determining a first sampling point based on the trajectory point;
if no, replacing the trajectory point with the last first sampling point in the two-dimensional point set; and obtaining the two-dimensional point set corresponding to a plurality of first sampling points obtained at the end of collection of the target video.

Optionally, the collecting a trajectory point of the target object from an image frame of the target video according to a predetermined sampling frequency may include: performing image sampling from the target video according to a predetermined sampling frequency to obtain an image frame, identifying a key point of the target object from the image frame, and determining that the key point of the target object is the trajectory point.

There may be a plurality of trajectory points, and the plurality of trajectory points may be respectively collected from the plurality of image frames.

Optionally, the sampling frequency may be set in advance and may be set according to a sampling time interval. A product of the sampling time interval and the sampling frequency may be 1, and the sampling time interval and the sampling frequency are reciprocal to each other.

Optionally, replacing the trajectory point with the last first sampling point in the two-dimensional point set includes: deleting the last first sampling point already existing in the two-dimensional point set, and taking the trajectory point as the new last first sampling point in the two-dimensional point set.

In the embodiments of the present disclosure, when the motion trajectory of the target object is sampled, the trajectory points may be preliminarily obtained according to the sampling of the image frame in the target video. Whether the trajectory points meet the distance constraint condition is determined. The trajectory points collected by different image frames are screened in more detail under the distance constraint condition, and the sampling accuracy of the first sampling point is improved.

In a possible design, determining whether the trajectory point satisfies the distance constraint condition based on the predetermined distance threshold includes:
determining a first distance between the trajectory point and a last first sampling point in the two-dimensional point set;
if the first distance is greater than the distance threshold, determining that the trajectory point satisfies the distance constraint condition;
if the first distance is less than or equal to the distance threshold, determining that the trajectory point does not satisfy the distance constraint condition.

Determining the first distance between the trajectory point and the last first sampling point in the two-dimensional point set may include: calculating a pixel coordinate distance according to the pixel coordinate of the trajectory point and the pixel coordinate of the last first sampling point in the two-dimensional point set, and determining the first distance according to the pixel coordinate distance. The distance unit of the pixel coordinate distance may be different from the distance unit of the first distance or may be the same. In different cases, the two distance units may be converted to achieve accurate comparison of distances in same unit.

The distance threshold may be a limit distance between two adjacent trajectory points.

In the embodiment of the disclosure, the first distance between the trajectory point and the last first sampling point in the two-dimensional point set is determined, the distance constraint is carried out on the trajectory points in the two-dimensional point set through the distance threshold, the condition that the distance from the collected sampling point is too abnormal is avoided, and accurate extraction of the sampling point is realized.

In the case that the trajectory point satisfies the distance constraint, further sampling may be performed on the trajectory point. Therefore, in a possible design, the determining the first sampling point based on the trajectory point includes:
obtaining the number of the first sampling points already existing in the two-dimensional point set.

If it is determined that the number of sampling points is less than or equal to the sampling number threshold, the trajectory point is added to the last first sampling point in the two-dimensional point set; if it is determined that the number of sampling points is greater than the sampling number threshold, the mean point is obtained based on the weighted summation of the previous N first sampling points and the trajectory point in the two-dimensional point set; the mean point is added as the last first sampling point in the two-dimensional point set; wherein N is a positive integer greater than 0.

If the distance between two adjacent points is relatively small, it may trigger a closed distance threshold determination. That is, if the distance between the current trajectory point and the previous point is less than the distance threshold, it may be determined that the trajectory is closed, resulting in invalid sampling or stopping sampling. Therefore, after the distance determination, the number of sampling points may be determined. After the number of sampling points currently drawn reaches the sampling point number threshold, through the constraint of the number of sampling points, weighted sampling is performed. The double constraint that the sampling process is subjected to the distance threshold and the sampling number threshold may improve the sampling accuracy.

Based on the weighted summation of the previous N first sampling points and the trajectory point in the two-dimensional point set, the mean point can be obtained, so that the drawing process of the trajectory points has a certain control effect, so that the finally obtained first sampling point is not limited to the trajectory point, the problem that the curve of the fitting is not smooth due to large fluctuation of the trajectory point is avoided, and the collected first sampling point can be smoother and higher in accuracy through weighted summation.

In the embodiment of the disclosure, the number of sampling points is determined by using the sampling number threshold, and whether the trajectory point can be directly used or not can be confirmed. With the weighted summation mode, the sampling points and the previous sampling points can be weighted and summed, so that the accuracy of the first sampling points is higher, and the first sampling points are accurately sampled.

As yet another optional implementation, the resampling the two-dimensional point set to obtain a plurality of second sampling points comprises:
performing curve fitting on a plurality of first sampling points in the two-dimensional point set based on a curve fitting algorithm to obtain a first spline;
performing curve fitting on a first sampling point and a last first sampling point in the two-dimensional point set to obtain a second spline;
obtaining a closed curve by joining the first spline and the second spline; and
resampling the closed curve according to a segmentation interval sampling strategy to obtain the plurality of second sampling points.

Optionally, the curve fitting algorithm may include any one of a Bezier curve algorithm or a Catmull-Rom curve algorithm.

Performing curve fitting on the first first sampling point and the last first sampling point in the two-dimensional point set to obtain the second spline may include: performing curve fitting on the first first sampling point and the last first sampling point in the two-dimensional point set according to the average curvature of the first spline, to obtain the second spline. The first first sample point and the last first sample point in the two-dimensional point set may also be directly connected to form a line segment, to obtain the second spline corresponding to the line segment.

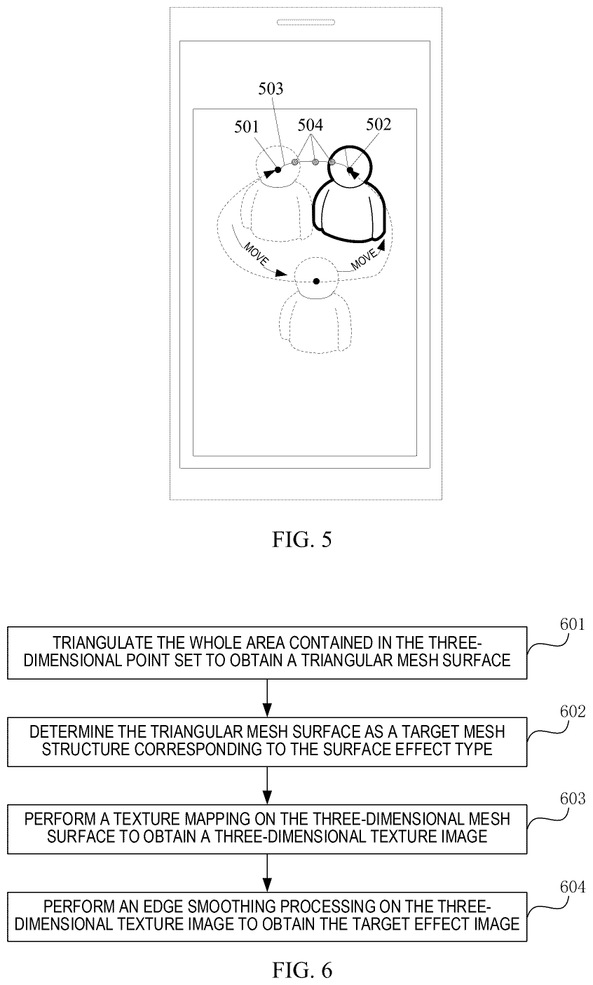

For ease of understanding, as shown in the sampling example diagram in FIG. 5, the first spline 503 obtained by fitting the sampling points between the first sampling point 501 and the last sampling point 502 is not closed. A the second spline 504 may be obtained by curve fitting. Then, the first spline 503 and the second spline 504 may be joined to form a closed curve.

In the embodiments of the present disclosure, a curve fitting may be performed to obtain a plurality of first sampling points in a two-dimensional point set for curve fitting, to obtain a first spline. In order to obtain a closed curve, curve fitting may be performed on the first sampling point and the last sampling point in the two-dimensional point set to obtain the second spline. By joining the first spline and the second spline, a closed curve is obtained. The closed curve corresponds to the motion trajectory, and the closed curve is segmented to obtain more detailed second sampling points.

In a possible design, resampling the closed curve according to the segment interval sampling policy to obtain the plurality of second sampling points includes:
determining the number of segments corresponding to the segment interval sampling policy;
segmenting the closed curve according to the number of segments to obtain at least one segmented curve;
collecting a second sampling point from the segmented curve to obtain a plurality of second sampling points corresponding to the at least one segmented curve.

Optionally, collecting the second sampling point from the segmented curve may include determining at least one curve sampling point from the segmented curve, and determining at least one curve sampling point as the second sampling point. It may further determine that the original first sampling point is the second sampling point. The plurality of second sampling points may include a plurality of first sampling points in the two-dimensional point set.

Optionally, segmenting the closed curve according to the number of segments may include: determining a segment length of the closed curve based on the number of segments, and segmenting the closed curve into at least one segmented curve based on the segment length and the number of segments. The number of curves of the at least one segmented curve may be equal to the number of segments.

In the embodiment of the disclosure, the closed curve is segmented in a segmentation mode to obtain at least one segmented curve, the segmented curve is a segment of line segments. By sampling from segmented curves, the plurality of second sampling points belong to the same line segment, thus the precision is higher.

As an optional implementation, determining the number of segments corresponding to the segment interval sampling policy may include:
determining a maximum segment number, a maximum input point number, and a minimum segment value corresponding to a spline interpolation algorithm;
determining the number of segments corresponding to the segment interval sampling policy based on the maximum segment number, the maximum input point number, and the minimum segment number.

Parameters such as a maximum segment number, a maximum input point number, and a minimum segment number may be set.

In the embodiment of the disclosure, the accurate number of segments is obtained according to the constraint of the maximum segment number, the maximum input point number and the minimum segment number.

In still another optional implementation, determining the number of segments corresponding to the segment interval sampling policy may include:
determining a curve length according to the sampling frequency and the sampling number;
taking the curve length as the number of sampling intervals;
calculating the number of segments according to the number of sampling intervals and the curve length.

According to the embodiment of the disclosure, the determined curve length is used for calculating the number of the segments, so that the number of the segments is matched with the curve length in real time, the dynamic adjustment of the number of the segments is realized, and the accurate number of the segments is obtained.

In one embodiment, respectively mapping at least one target sampling point to a three-dimensional space coordinate system to obtain a three-dimensional point set comprises:
converting the target sampling points into a three-dimensional space coordinate system according to a camera conversion matrix corresponding to cameras for rendering the target video, to obtain three-dimensional conversion coordinates respectively corresponding to the target sampling points;
obtaining a three-dimensional point set composed of three-dimensional conversion coordinates corresponding to respective target sampling points.

Optionally, the camera conversion matrix may be obtained through matrix calculation through parameters of the camera, and parameters of the camera may include an intrinsic parameter of the camera and an extrinsic parameter of the camera.

The target sampling point may be a point in a two-dimensional image coordinate system, the target sampling point is converted into a three-dimensional space coordinate system with data such as camera conversion matrix, to obtain three-dimensional conversion coordinates. The conversion of the image coordinate system, the camera coordinate system, and the space coordinate system may refer to the description of the related art.

In the embodiment of the disclosure, the three-dimensional space coordinate system conversion may be carried out on the target sampling point according to the depth information of each target sampling point in combination with the camera conversion distance of the camera coordinate system, and accurate conversion of pixel points of the three-dimensional space coordinate system is realized.

After the plurality of second sampling points are obtained, whether the plurality of second sampling points protrude may be confirmed.

In a possible design, the determining, from the plurality of second sampling points, at least one target sampling point meeting a trajectory smoothing condition comprises:
combining two adjacent sampling points in the plurality of second sampling points to obtain at least one group of sampling points;
determining tangent vectors corresponding to two second sampling points in each group of sampling points;
for the at least one group of sampling points, in response to the tangent vectors in a target group being less than zero, determining any one of the two second sampling points in the target group as the target sampling point;
in response to the tangent vectors in the target group being greater than or equal to zero, determining that the two second sampling points in the target group are both the target sampling points; and
obtaining all target sampling points corresponding to the at least one group of sampling points as the at least one target sampling point.

The calculating step of the tangent vectors of the two second sampling points may include calculating the tangent vector by using the fitted arc based on the arc fitting of the two sampling points.

In the embodiment of the present disclosure, for the second sampling point, two adjacent sampling points may be divided into a group of sampling points, and whether the tangent vector of each group of sampling points is greater than zero may be determined. The tangent vector is greater than zero, it indicates that the two second sampling points in the group are smaller in difference, and the two sampling points may be reserved. If the tangent vector is less than zero, it indicates that the two second sampling points in the group are larger in difference, one sampling point is more prominent, the presentation of the effect may be affected, and therefore any one of the second sampling points may be reserved. Through the determination of the tangent vector, the salient points in the adjacent sampling points may be processed, and the processing efficiency of the sampling points is improved.

Certainly, in order to improve the screening efficiency of the smoothing condition, in another possible design, the determining at least one target sampling point meeting the trajectory smoothing condition from the second sampling point includes:
determining whether the second sampling point belongs to a point on the smooth curve;
if yes, determining that the second sampling point satisfies the trajectory smoothing condition;
if not, determining that the second sampling point does not meet the trajectory smoothing condition, and returning to the step of determining whether the second sampling points belong to a point on the smooth curve based on the edge average sampling algorithm;
obtaining the target sampling points meeting the trajectory smoothing condition when the second sampling point traversal ends.

Optionally, determining whether the second sampling point belongs to a point on the smooth curve may include: performing curve fitting on the second sampling point to obtain a fitting curve, calculating an absolute distance from each second sampling point to the fitting curve, and if the absolute distance is greater than the absolute threshold, determining that the second sampling point meets the trajectory smoothing condition; and if the absolute distance is less than or equal to the absolute threshold, determining that the second sampling point does not meet the trajectory smoothing condition.

In the embodiment of the disclosure, whether the second sampling point belongs to a point on the smooth curve or not may be determined based on the edge average sampling algorithm. Whether the sampling point belongs to a relatively prominent sharp point or not may be detected through determination of the smooth curve. In such way, the target sampling point is the point along the smooth curve, and when the effect is generated based on the at least one target sampling point, the contour of the effect image is smooth, no sharp part exists, and then at least one target sampling point with smoother contour is obtained.

As shown in FIG. 6, which is a flowchart of a method for drawing an effect image according to an embodiment of the present disclosure. The difference between this method for drawing an effect image and the previous embodiment is that the three-dimensional point set is meshed to obtain the target mesh structure, comprising:
601: triangulating the whole area contained in the three-dimensional point set to obtain a triangular mesh surface; and
602: determining the triangular mesh surface as a target mesh structure corresponding to the surface effect type.

The performing a map processing on the target mesh structure to obtain a target effect image comprises:
603: performing a texture mapping on the three-dimensional mesh surface to obtain a three-dimensional rendered target texture image; and
604: performing an edge smoothing processing on the three-dimensional rendered target texture image to obtain the target effect image.

Optionally, the triangular mesh surface may be obtained by connecting a plurality of points in the three-dimensional point set to form a mesh.

Performing edge smoothing processing on the three-dimensional rendered target texture image may refer to performing smoothing processing on a mesh edge of the three-dimensional rendered target texture image.

In the embodiments of the present disclosure, a triangular mesh surface may be generated according to a network topology of the three-dimensional points set, and the triangular mesh surface is used as a target mesh structure to perform map processing to obtain a three-dimensional texture map. Through network processing, an accurate triangular mesh surface can be obtained. After the three-dimensional rendered target texture image is obtained, edge smoothing processing may be performed on the three-dimensional rendered target texture image to obtain the target effect image. Through edge smoothing processing, the target effect image can be smoother, and the display effect is better.

In an embodiment, the triangulating the whole area contained in the three-dimensional point set to obtain a triangular mesh surface comprises:
determining a center point corresponding to the three-dimensional point set;
constructing a fan surface mesh topology based on the three-dimensional point set and the central point to obtain a three-dimensional topological structure;
converting the boundary value of the three-dimensional topological structure to a calculated value of a percentage coordinate system of the image; and
determining the triangular mesh surface based on the three-dimensional topological structure and a calculated value of each point on the three-dimensional topological structure.

Optionally, determining the center point corresponding to the three-dimensional point set may include the following implementations:
Implementation 1: solving the internal gravity center of the convex polygon corresponding to the three-dimensional point set to obtain the central point.
Implementation 2: perform circular fitting processing on the contour of the three-dimensional point set to obtain a circle center of the fitted circle as a center point.
Implementation 3: Delaunay triangulation is performed on the three-dimensional point set, and if the points in the three-dimensional point set are not in all triangulated triangles, it indicates that the circle center/gravity center is outside the convex polygon corresponding to the three-dimensional point set, and the mean value of all points in the three-dimensional point set may be calculated as the central point.

The convex polygon may be a multi-edge graph formed by connecting edge points in the three-dimensional point set.

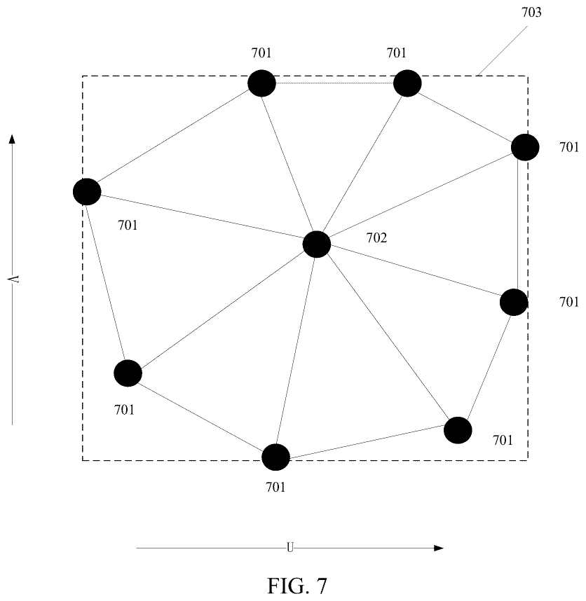

For ease of understanding, FIG. 7 shows a triangulation example diagram of a three-dimensional point set. The three-dimensional point set is mapped into a plan view, referring to FIG. 7, a point of the three-dimensional point set is 701, and a center point is 702. The points 701 of two adjacent three-dimensional point sets and the center point 702 may be connected in pairs to form a triangle, to obtain a corresponding three-dimensional topological structure 703. Of course, the three-dimensional point set shown in FIG. 7 is merely an example. In practical application, a three-dimensional point set may change along with the motion trajectory. The three-dimensional topological structure 703 may be mapped to the UV coordinate system to obtain the UV values of each point, in order to obtain the triangular mesh surface.

The boundary value of the three-dimensional topological structure may refer to a boundary size of the three-dimensional topological structure, for example, a length and a width of the three-dimensional topological structure. The length and width are actually a nominal value.

The percentage coordinates of an image may refer to a UV coordinate system. When the mapping is performed on the three-dimensional topological structure, in order to ensure that the fitting of the image is tighter with the three-dimensional topological structure, and no excessive fitting phenomenon occurs, the boundary value of the three-dimensional topological structure may be determined to be converted into the calculated value of the UV coordinate system. The UV coordinate is the percentage coordinate of the image, the horizontal direction is U, and the vertical direction is V. For example, it is assumed that the three-dimensional topological structure includes four boundary points of a top-left point, a top-right point, a bottom-left point, and a bottom-right point. It can be determined that the top-left U is equal to 0, V is equal to 0, the bottom-right U is equal to 1, V is equal to 1, the top-right U is equal to 1, V is equal to 0, the bottom-left U is equal to 0, V is equal to 1, specifically they may be the calculated values of the four corners of the three-dimensional topological structure in the UV coordinate system, and the UV value of the central point of the three-dimensional topological structure may be U equal to 0.5 and V is equal to 0.5.

When the three-dimensional mesh surface is mapped, the mapping may be performed by using the calculated value of each point, that is, the UV value.

In the embodiment of the disclosure, when the triangular mesh surface is generated, the fan surface network topology can be constructed according to the central point of the three-dimensional point set, a three-dimensional topological structure is obtained, the boundary value of the three-dimensional topological structure is converted into the UV calculation value, the three-dimensional topological structure can be marked in the UV coordinate system, and the triangular mesh surface with the coordinate structure is obtained. Accurate triangular mesh surfaces can be obtained through surface construction and coordinate conversion, and accurate execution of subsequent effect maps is ensured.

In a possible design, performing edge smoothing processing on the three-dimensional rendered target texture image to obtain the target effect image comprises:
rendering each pixel of the three-dimensional rendered target texture image into a rendering texture with each channel value being zero, to obtain a first texture map;
drawing an alpha channel of the first texture map into a grayscale rendering texture to obtain a grayscale mask map;
performing a corrosion processing and a blur processing on the grayscale mask map to obtain a smooth mask map; and
performing an image fusion processing on the smooth mask map and the first texture map to obtain the target effect image.

Optionally, the texture image and the rendering texture may include four channels of red (R), green (G), blue (B), and alpha (A), and each channel may correspond to a channel value at a pixel.

Optionally, the channel value of each channel in the render texture (RT) may be 0, that is, the initial value of each pixel is (0, 0, 0, 0), and the background of the rendered texture is transparent when the channel value of each pixel is 0.

The grayscale rendering texture may refer to that the pixel value of the rendered texture is a grayscale value of 0-1. For example, the color value corresponding to the alpha channel value of 0 is (0, 0, 0), that is, pure black; the color value corresponding to the alpha channel value of 1 is (1, 1, 1), and the alpha channel value in the 0-1 interval corresponds to the gray color value of (alpha, alpha, alpha).

The grayscale mask map may be used to mark the mask of the first texture map, so that the contour of the target effect image is affected by the grayscale mask map and is converted into the contour of the polygon.

Optionally, performing corrosion processing and blur processing on the grayscale mask map to obtain a smooth mask map may include performing corrosion processing on the grayscale mask map to obtain a corrosion mask map, and performing blur processing on the corrosion mask map to obtain a smooth mask map. The blur processing on the corrosion mask map may include: performing blur processing on the corrosion mask map based on a Gaussian function.

According to the embodiment of the disclosure, the three-dimensional rendered target texture image is drawn to the rendering texture with the initial value of zero, the first texture map is obtained, the alpha channel value of the first texture map is drawn to the gray level rendering texture to obtain the gray scale mask map, and the corrosion processing and blur processing are performed on the gray scale mask map to obtain a smoother smooth mask map. Image fusion processing is performed on the first texture map by using the smooth mask map, and the contour of the image may be smoothed to obtain the target effect image with smoother contour.

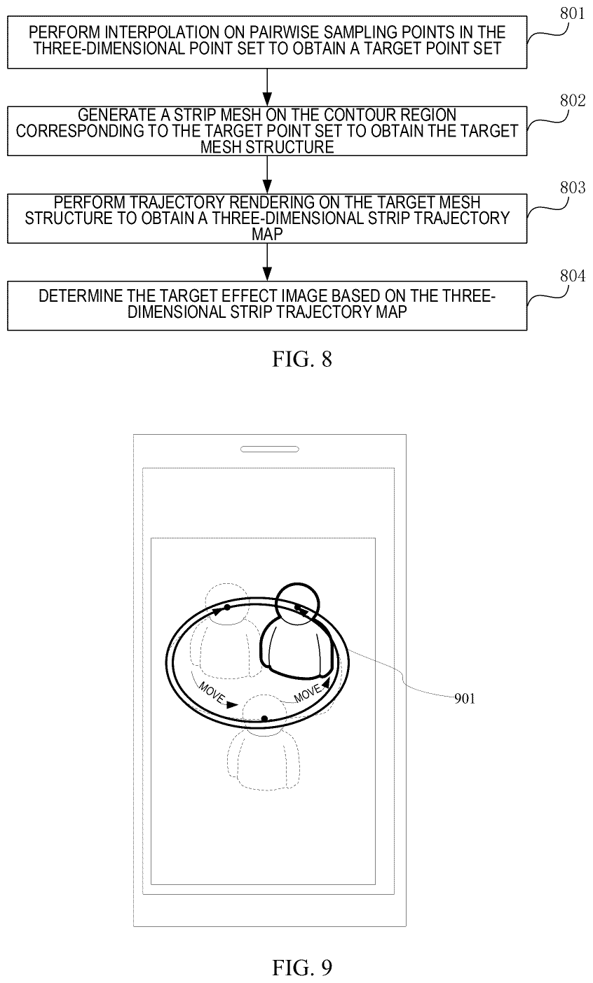

As shown in FIG. 8, which is a flowchart of a method for drawing an effect image according to an embodiment of the present disclosure. The difference between this method for drawing an effect image and previous embodiment is in that, performing a meshing processing on the three-dimensional point set to obtain a target mesh structure comprises:

801: performing interpolation on pairwise adjacent sampling points in the three-dimensional point set to obtain a target point set.

Optionally, performing interpolation on pairwise adjacent sampling points in the three-dimensional point set may refer to interpolating two adjacent sampling points in the three-dimensional point set until every two adjacent sampling points in the three-dimensional point set are sampled.

An interpolation process based on a Catmull curve may be used to obtain a denser target point set.
802: generating a strip mesh on the contour region corresponding to the target point set to obtain the target mesh structure.
performing a map processing on the target mesh structure to obtain the target effect image comprises:
803: performing trajectory rendering on the target mesh structure to obtain a three-dimensional strip trajectory map; and
804: determining the target effect image based on the three-dimensional strip trajectory map.

For ease of understanding, FIG. 9 shows an example diagram of an annular strip-shaped effect image, and the three-dimensional strip-shaped trajectory diagram 901 may be used to determine a target effect image, and shows an annular effect.

Optionally, the target effect image may have a translucent characteristic. The rendering transparency may be set in advance according to the use requirement, and may be a numerical value greater than 0 and less than or equal to 1, and may be a decimal between 0-1.

In the embodiment of the disclosure, a strip-shaped network corresponding to the target point set can be generated, a strip-shaped target network structure can be obtained, and the strip-shaped mesh is generated. By performing map processing on the strip-shaped target mesh structure, a three-dimensional strip-shaped trajectory map may be obtained. The three-dimensional strip-shaped trajectory map may be used to determine a target effect image. The strip-shaped target mesh structure is established for the mesh, and accurate generation of the strip-shaped target effect image is realized.

In an embodiment, the determining the target effect image according to the three-dimensional strip trajectory comprises:
rendering the three-dimensional strip trajectory to a rendering texture with each channel value of zero to obtain a second texture map; and
performing a transparency processing on the second texture map according to a rendering transparency to obtain the target effect image.

Optionally, the second texture map may be a rendered image that displays a three-dimensional strip trajectory.

In the embodiment of the disclosure, the RT may be used for edge smoothing of the three-dimensional strip-shaped trajectory, the obtained strip-shaped shape of the target effect image is smoother, and the display effect is better.

In a possible design, the method further includes:
determining a trigger time of the effect drawing request triggered by the user;
determining a target holiday type corresponding to the trigger time according to a time period corresponding to at least one holiday type; and
obtaining a texture image pre-associated with the target holiday type,
wherein the performing a map processing on the target mesh structure to obtain a target effect image comprises:
performing the map processing on the target mesh structure by using the texture image to obtain the target effect image.

Optionally, at least one holiday type may be set, and a time period corresponding to each holiday type is known. For example, the corresponding time period of Mid-Autumn Festival is known. Texture images can be pre-associated for each holiday typ. For example, the texture image of the Mid-Autumn Festival may be a moon texture image, and the texture image of the Dragon Boat Festival may be a rice dumpling leaf texture image.

In the embodiment of the disclosure, the target holiday type is determined through the triggering time of the effect drawing request, and the texture image corresponding to the target holiday type is mapped, so that the texture of the target effect image is matched with the target holiday type in real time, the application time is longer, and higher display efficiency can be obtained.

The technical solutions of the present disclosure may be applied to a plurality of actual application scenarios, and a specific application scenario of the present disclosure is described in detail below.

Scenario 1, in a traditional holiday scenario, such as Dragon Boat Festival, Mid-Autumn Festival and other holidays, a user initiates an effect drawing request, a texture image corresponding to holiday may be obtained based on the technical solution of the present disclosure, and a map processing is performed on a target mesh structure obtained based on some steps of the present disclosure, for example, a moon texture is mapped to obtain an effect moon, so as to display an effect moon on the corresponding display of the motion trajectory of the video.

Scenario 2, in an AR scenario, an effect image may be generated for the tracked vehicle or person based on the technical solution of the present disclosure, the generated effect image is a three-dimensional effect image, the generated three-dimensional effect image may be displayed in the AR device, the reality enhancement is realized, and the utilization rate of the effect is improved.

In addition, the technical solution of the present disclosure may also be applied to the fields of video playing and AR, and may specifically include, for example, a special holiday scene effect, a user's trajectory tracking effect application, and the like.

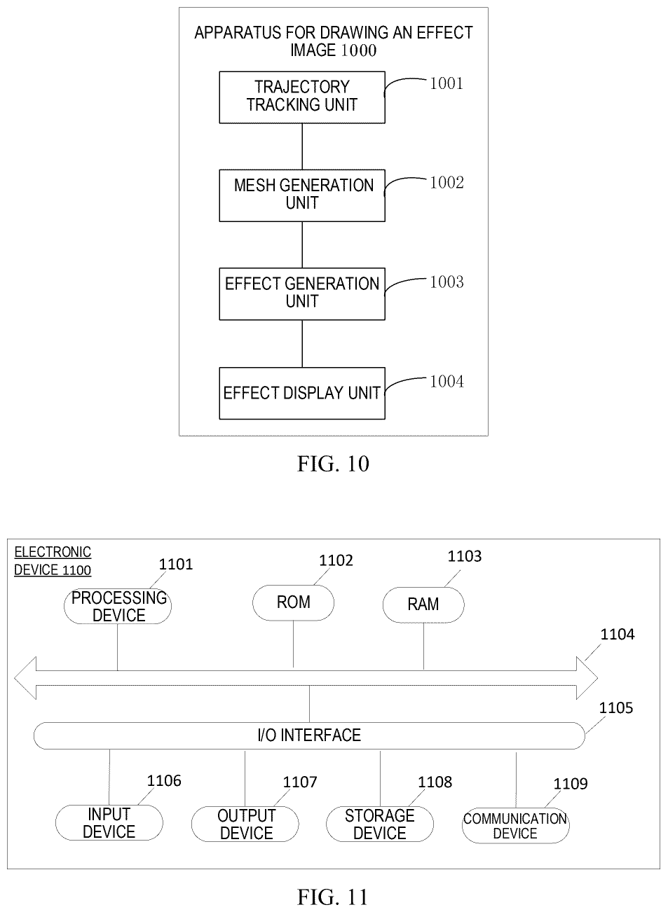

As shown in FIG. 10, which is a schematic structural diagram of an apparatus for drawing an effect image according to an embodiment of the present disclosure. This apparatus may be located in an electronic device and can be configured with the above-mentioned method for drawing an effect image. The apparatus 1000 for drawing an effect image may comprises:
a trajectory tracking unit 1001 configured to, in response to an effect drawing request triggered by a user, perform trajectory tracking on a target video provided by the user, to obtain a three-dimensional point set corresponding to a motion trajectory of a target object in the target video;
a mesh generation unit 1002 configured to perform a meshing processing on the three-dimensional point set to obtain a target mesh structure;
an effect generation unit 1003 configured to perform a map processing on the target mesh structure to obtain a target effect image; and
an effect display unit 1004 configured to display, in the target video, the target effect image corresponding to the motion trajectory of the target object.

In one embodiment, the trajectory tracking unit comprises:
an object recognizing module configured to recognize the target object in the target video;
a trajectory sampling module configured to sample the motion trajectory of the target object in the target video to obtain at least one target sampling point; and
a space mapping module configured to map the at least one target sampling point to a three-dimensional space coordinate system to obtain the three-dimensional point set.

In some embodiments, the trajectory sampling module comprises:
a trajectory sampling sub-module configured to sample the motion trajectory of the target object from the target video to obtain a two-dimensional point set, the two-dimensional point set comprising a plurality of first sampling points;
a resampling sub-module configured to resample the two-dimensional point set to obtain a plurality of second sampling points; and
a sample selecting sub-module configured to determine, from the plurality of second sampling points, at least one target sampling point meeting a trajectory smoothing condition.

In a possible design, the trajectory sampling sub-module is specifically configured to:
collect a trajectory point of the target object from an image frame of the target video according to a predetermined sampling frequency;
determine whether the trajectory point satisfies a distance constraint condition based on a predetermined distance threshold;
if yes, determine a first sampling point based on the trajectory point;
if no, replace the trajectory point with the last first sampling point in the two-dimensional point set; and obtain the two-dimensional point set corresponding to a plurality of first sampling points obtained at the end of collection of the target video.

In a possible design, the trajectory sampling sub-module is specifically configured to:
determine a first distance between the trajectory point and a last first sampling point in the two-dimensional point set;
if the first distance is greater than the distance threshold, determine that the trajectory point satisfies the distance constraint condition;
if the first distance is less than or equal to the distance threshold, determine that the trajectory point does not satisfy the distance constraint condition.

In a possible design, the trajectory sampling sub-module is specifically configured to:
acquire a number of sampling points of a first sampling points already existing in the two-dimensional point set;
if it is determined that the number of sampling points is less than or equal to the sampling number threshold, add the trajectory point as the last first sampling point in the two-dimensional point set;
if it is determined that the number of sampling points is greater than the sampling number threshold, obtain the mean point based on the weighted summation of the first N first sampling points in the two-dimensional point set and the trajectory points; and add the mean point as the last first sampling point in the two-dimensional point set; N is a positive integer greater than 0.

In some embodiments, the resampling sub-module is specifically configured to:
perform curve fitting on a plurality of first sampling points in the two-dimensional point set based on a curve fitting algorithm to obtain a first spline;
performg curve fitting on a first sampling point and a last first sampling point in the two-dimensional point set to obtain a second spline;
obtain a closed curve by joining the first spline and the second spline; and resampling the closed curve according to a segmentation interval sampling strategy to obtain the plurality of second sampling points.

In some embodiments, the resampling sub-module is specifically configured to:
determine a number of segments corresponding to the segmentation interval sampling policy; and
segment the closed curve according to the number of segments to obtain at least one segmented curve;
collect a second sampling point from the segmented curve to obtain a plurality of second sampling points corresponding to the at least one segmented curve.

In one embodiment, the sample selecting sub-module may be specifically configured to:
combine two adjacent sampling points in the plurality of second sampling points to obtain at least one group of sampling points;
determine a dot product result corresponding to two second sampling points in each group of sampling points, the dot product result being obtained by computing a dot product of tangent vectors of two second sampling points;
for the at least one group of sampling points, in response to the dot product result corresponding to the two second sampling points in a target group being less than zero, determine any one of the two second sampling points in the target group as the target sampling point;
in response to the dot product result corresponding to the two second sampling points of the target group being greater than or equal to zero, determine that the two second sampling points in the target group are both the target sampling points; and
obtain all target sampling points corresponding to the at least one group of sampling points as the at least one target sampling point.

In one embodiment, the space mapping module may comprise:
a matrix conversion submodule, configured to convert the target sampling point into the spatial coordinate system according to the camera conversion matrix corresponding to the camera for rendering the target video, to obtain three-dimensional conversion coordinates respectively corresponding to the target sampling points;
a point set determining sub-module, configured to obtain a three-dimensional point set composed of three-dimensional conversion coordinates corresponding to respective target sampling point.

In another embodiment, the mesh generation unit may include:
a first processing module, configured to triangulate the whole area contained in the three-dimensional point set to obtain a triangular mesh surface; and
a first determination module, configured to determine the triangular mesh surface as a target mesh structure corresponding to the surface effect type.

The effect generation unit may comprise:
a first mapping module, configured to perform a texture mapping on the three-dimensional mesh surface to obtain a three-dimensional rendered target texture image; and
an edge smoothing module, configured to perform an edge smoothing processing on the three-dimensional rendered target texture image to obtain the target effect image.

In some embodiments, the first processing module comprises:
a center determination sub-module, configured to determine a center point corresponding to the three-dimensional point set;
a topology constructing sub-module, configured to construct a fan surface mesh topology based on the three-dimensional point set and the central point to obtain a three-dimensional topological structure;
a coordinate calculating sub-module, configured to convert the boundary value of the three-dimensional topological structure to a calculated value of a percentage coordinate system of the image; and
a surface determination sub-module, configured to determine the triangular mesh surface based on the three-dimensional topological structure and a calculated value of each point on the three-dimensional topological structure.

In an embodiment, the edge smoothing module comprises:
a first rendering sub-module, configured to render each pixel of the three-dimensional rendered target texture image into a rendering texture with each channel value being zero, to obtain a first texture map;
a second rendering sub-module, configured to draw an alpha channel of the first texture map into a grayscale rendering texture to obtain a grayscale mask map;
a corrosion-blur sub-module, configured to perform a corrosion processing and a blur processing on the grayscale mask map to obtain a smooth mask map; and
an image fusion sub-module, configured to perform an image fusion processing on the smooth mask map and the first texture map to obtain the target effect image.

In an embodiment, the mesh generation unit comprises:
a point set interpolation module, configured to perform interpolation on pairwise adjacent sampling points in the three-dimensional point set to obtain a target point set;
a mesh generation module, configured to generate a strip mesh on the contour region corresponding to the target point set to obtain the target mesh structure;
the effect generation unit comprises:
a trajectory rendering module, configured to perform trajectory rendering on the target mesh structure to obtain a three-dimensional strip trajectory map; and
a trajectory processing module, configured to determine the target effect image based on the three-dimensional strip trajectory map.

In a possible design, the trajectory processing module comprises:
a third rendering sub-module, configured to render the three-dimensional strip trajectory to a rendering texture with each channel value of zero to obtain a second texture map; and
a transparency processing sub-module, configured to perform a transparency processing on the second texture map according to a rendering transparency to obtain the target effect image.

In a possible design, the method further comprises:
a time determination unit, configured to determine a trigger time of the effect drawing request triggered by the user;
a holiday determination unit, configured to determine a target holiday type corresponding to the trigger time according to a time period corresponding to at least one holiday type; and
a texture association unit, configured to obtain a texture image pre-associated with the target holiday type,
the effect generation unit comprises:
a second mapping module, configured to perform the map processing on the target mesh structure by using the texture image to obtain the target effect image.

The apparatus provided in this embodiment may be configured to perform the technical solutions in the foregoing method embodiments, and implementation principles and technical effects thereof are similar, and details are not described herein again in this embodiment.

In order to achieve the above embodiments, an embodiment of the present disclosure further provides an electronic device.

Referring to FIG. 11, which shows a schematic structural diagram of an electronic device 1100 suitable for implementing embodiments of the present disclosure. The electronic device 1100 may be a terminal device or a server. The terminal device may include, but is not limited to, a mobile terminal such as a mobile phone, a notebook computer, a digital broadcast receiver, a personal digital assistant (PDA), a portable Android device (PAD), a portable media player (PMP), an on-board terminal (for example, an on-board navigation terminal), as well as a fixed terminal such as a digital television (TV), a desktop computer, or the like. The electronic device shown in FIG. 11 is merely an example and should not impose any limitation on the functions and scope of use of the embodiments of the present disclosure.

As shown in FIG. 11, the electronic device 1100 may comprise a processing device (for example, a central processing unit, a graphics processor, etc.) 1101, which may perform various appropriate actions and processes according to a program stored in a read only memory (ROM) 1102 or a program loaded into a random access memory (RAM) 1103 from a storage device 1108. In the RAM 1103, there are also stored various programs and data required by the the electronic device 1100 when operating. The processing device 1101, the ROM 1102, and the RAM 1103 are connected to each other through a bus 1104. An input/output (I/O) interface 1105 is also connected to the bus 1104.

Generally, the following devices may be connected to the I/O interface 1105: an input device 1106 including, for example, a touch screen, a touch pad, a keyboard, a mouse, a camera, a microphone, an accelerometer, a gyroscope, etc.; an output device 1107 including, for example, a liquid crystal display (LCD), a speaker, a vibrator, etc.; a storage device 1108 including, for example, a magnetic tape, a hard disk, etc.; and a communication device 1109. The communication device 1109 may allow the electronic device 1100 to communicate wirelessly or wired with other devices to exchange data. While FIG. 11 shows an electronic device 1100 with various devices, it should be understood that it is not required to implement or have all illustrated devices. More or fewer devices may alternatively be implemented or provided.

In particular, according to an embodiment of the present disclosure, the process described above with reference to the flowchart may be implemented as a computer software program. For example, embodiments of the present disclosure include a computer program product comprising a computer program embodied on a computer readable medium, the computer program comprising program code for performing the method shown in the flowchart. In such embodiments, the computer program may be downloaded and installed from the network through the communication device 1109, or installed from the storage device 1108, or from the ROM 1102. When the computer program is executed by the processing apparatus 1101, the foregoing functions defined in the method of the embodiments of the present disclosure are performed.

It should be noted that the computer-readable medium described above may be a computer readable signal medium, a computer readable storage medium, or any combination of the foregoing two. The computer-readable storage medium may be, for example, but not limited to, an electrical, magnetic, optical, electromagnetic, infrared, or semiconductor system, apparatus, or device, or any combination thereof. More specific examples of the computer-readable storage medium may include, but are not limited to, an electrical connection having one or more wires, a portable computer diskette, a hard disk, a random access memory (RAM), a read-only memory (ROM), an erasable programmable read-only memory (EPROM), an optical fiber, a portable compact disk read-only memory (CD-ROM), an optical storage device, a magnetic storage device, or any suitable combination thereof. In the present disclosure, a computer-readable storage medium may be any tangible medium containing or storing a program that may be used by or in connection with an instruction execution system, apparatus, or device. In the present disclosure, a computer readable signal medium may include a data signal propagated in baseband or as part of a carrier, where the computer readable program code is carried. Such propagated data signals may take a variety of forms including, but not limited to, electromagnetic signals, optical signals, or any suitable combination of the foregoing. The computer readable signal medium may also be any computer readable medium other than a computer readable storage medium that may send, propagate, or transmit a program for use by or in connection with an instruction execution system, apparatus, or device. The program code embodied on the computer-readable medium may be transmitted by any suitable medium, including but not limited to, wires, optical cables, Radio Frequency (RF), and the like, or any suitable combination thereof.

The computer-readable medium described above may be included in the electronic device; or may be separately present without being assembled into the electronic device.

The computer-readable medium carries one or more programs, and when the one or more programs are executed by the electronic device, the electronic device is enabled to perform the method shown in the foregoing embodiments.

Computer program code for performing the operations of the present disclosure may be written in one or more programming languages, including object oriented programming languages, such as Java, Smalltalk, C++, and conventional procedural programming languages, such as the “C” language or similar programming languages. The program code may execute entirely on a user computer, partially on a user computer, as a stand-alone software package, partially on a user computer, partially on a remote computer, or entirely on a remote computer or server. In the case of a remote computer, the remote computer may be connected to the user computer through any kind of network, including a local area network (LAN) or a wide area network (WAN), or may be connected to an external computer (e.g., connected via the Internet using an Internet service provider).

The flowcharts and block diagrams in the figures illustrate architecture, functionality, and operation of possible implementations of systems, methods, and computer program products according to various embodiments of the present disclosure. In this regard, each block in the flowchart or block diagram may represent a module, program segment, or portion of code that includes one or more executable instructions for implementing the specified logical function. It should also be noted that in some alternative implementations, the functions noted in the blocks may also occur in a different order than that illustrated in the figures. For example, two consecutively represented blocks may actually be performed substantially in parallel, which may sometimes be performed in the reverse order, depending on the functionality involved. It is also noted that each block in the block diagrams and/or flowcharts, as well as combinations of blocks in the block diagrams and/or flowcharts, may be implemented with a dedicated hardware-based system that performs the specified functions or operations, or may be implemented in a combination of dedicated hardware and computer instructions.

The units involved in the embodiments of the present disclosure may be implemented in software, or may be implemented in hardware. For example, the first obtaining unit may be further described as “a unit that obtains at least two Internet Protocol addresses”.

The functions described above may be performed, at least in part, by one or more hardware logic components. For example, without limitation, the exemplary types of hardware logic components that may be used include: a Field-Programmable Gate Array (FPGA), an Application Specific Standard (ASIC), an Application Specific Standard (ASSP), a System On Chip (SOC), a Complex Programmable Logic Device (CPLD), or the like.

In the context of the present disclosure, a machine-readable medium may be a tangible medium that may contain or store a program for use by or in connection with an instruction execution system, apparatus, or device. The machine-readable medium may be a machine-readable signal medium or a machine-readable storage medium. The machine-readable medium may include, but is not limited to, electronic, magnetic, optical, electromagnetic, infrared, or semiconductor systems, devices, or devices, or any suitable combination of the foregoing. More specific examples of machine-readable storage media may include electrical connections based on one or more lines, portable computer disks, hard disks, random access memory (RAM), read-only memory (ROM), erasable programmable read-only memory (EPROM or Flash memory), optical fibers, portable compact disc read-only memory (CD-ROM), optical storage devices, magnetic storage devices, or any suitable combination of the foregoing.

In a first aspect, a method for drawing an effect image is provided according to one or more embodiments of the present disclosure, comprising:
in response to an effect drawing request triggered by a user, performing trajectory tracking on a target video provided by the user to obtain a three-dimensional point set corresponding to a motion trajectory of a target object in the target video;
performing a meshing processing on the three-dimensional point set to obtain a target mesh structure;
performing a map processing on the target mesh structure to obtain a target effect image; and
displaying, in the target video, the target effect image corresponding to the motion trajectory of the target object.

According to one or more embodiments of this disclosure, the performing trajectory tracking on a target video provided by the user to obtain a three-dimensional target point set corresponding to a motion trajectory of a target object in the target video comprises:
recognizing the target object in the target video;
sampling the motion trajectory of the target object in the target video to obtain at least one target sampling point; and
mapping the at least one target sampling point to a three-dimensional space coordinate system to obtain the three-dimensional point set.

According to one or more embodiments of this disclosure, the sampling the motion trajectory of the target object in the target video to obtain at least one target sampling point comprises:
sampling the motion trajectory of the target object from the target video to obtain a two-dimensional point set, the two-dimensional point set comprising a plurality of first sampling points;
resampling the two-dimensional point set to obtain a plurality of second sampling points; and
determining, from the plurality of second sampling points, at least one target sampling point meeting a trajectory smoothing condition.

According to one or more embodiments of this disclosure, the sampling the motion trajectory of the target object from the target video to obtain a two-dimensional point set comprises:
collecting a trajectory point of the target object from an image frame of the target video according to a predetermined sampling frequency;
determining whether the trajectory point satisfies a distance constraint condition based on a predetermined distance threshold;
if yes, determining a first sampling point based on the trajectory point;
if no, replacing the trajectory point with the last first sampling point in the two-dimensional point set; and
obtaining the two-dimensional point set corresponding to a plurality of first sampling points obtained at the end of collection of the target video.

According to one or more embodiments of this disclosure, the determining whether the trajectory point satisfies a distance constraint condition based on a predetermined distance threshold comprises:
determining a first distance between the trajectory point and a last first sampling point in the two-dimensional point set;
if the first distance is greater than the distance threshold, determine that the trajectory point satisfies the distance constraint condition;
if the first distance is less than or equal to the distance threshold, determine that the trajectory point does not satisfy the distance constraint condition.

According to one or more embodiments of this disclosure, determining the first sampling point base on a trajectory point comprises:
acquiring a number of sampling points of a first sampling points already existing in the two-dimensional point set;
if it is determined that the number of sampling points is less than or equal to the sampling number threshold, adding the trajectory point as the last first sampling point in the two-dimensional point set;
if it is determined that the number of sampling points is greater than the sampling number threshold, obtaining the mean point based on the weighted summation of the first N first sampling points in the two-dimensional point set and the trajectory points; and adding the mean point as the last first sampling point in the two-dimensional point set; wherein N is a positive integer greater than 0.

According to one or more embodiments of this disclosure, the resampling the two-dimensional point set to obtain a plurality of second sampling points comprises:
performing curve fitting on a plurality of first sampling points in the two-dimensional point set based on a curve fitting algorithm to obtain a first spline;
performing curve fitting on a first sampling point and a last first sampling point in the two-dimensional point set to obtain a second spline;
obtaining a closed curve by joining the first spline and the second spline; and
resampling the closed curve according to a segmentation interval sampling strategy to obtain the plurality of second sampling points.

According to one or more embodiments of this disclosure, the resampling the closed curve according to a segmentation interval sampling strategy to obtain the plurality of second sampling points comprises:
determining a number of segments corresponding to the segmentation interval sampling policy; and
segmenting the closed curve according to the number of segments to obtain at least one segmented curve;
collecting a second sampling point from the segmented curve to obtain a plurality of second sampling points corresponding to the at least one segmented curve.

According to one or more embodiments of this disclosure, the determining, from the plurality of second sampling points, at least one target sampling point meeting a trajectory smoothing condition comprises:
combining two adjacent sampling points in the plurality of second sampling points to obtain at least one group of sampling points;
determining a dot product result corresponding to two second sampling points in each group of sampling points, the dot product result being obtained by computing a dot product of tangent vectors of two second sampling points;
for the at least one group of sampling points, in response to the dot product result corresponding to the two second sampling points in a target group being less than zero, determining any one of the two second sampling points in the target group as the target sampling point;
in response to the dot product result corresponding to the two second sampling points of the target group being greater than or equal to zero, determining that the two second sampling points in the target group are both the target sampling points; and
obtaining all target sampling points corresponding to the at least one group of sampling points as the at least one target sampling point.

According to one or more embodiments of this disclosure, the mapping the at least one target sampling point to a three-dimensional space coordinate system to obtain the three-dimensional point set comprising:
converting the target sampling point into the spatial coordinate system according to the camera conversion matrix corresponding to the camera for rendering the target video, to obtain three-dimensional conversion coordinates respectively corresponding to the target sampling points;
obtaining a three-dimensional point set composed of three-dimensional conversion coordinates corresponding to respective target sampling point.

According to one or more embodiments of this disclosure, performing a meshing processing on the three-dimensional point set to obtain a target mesh structure comprises:
triangulating the whole area contained in the three-dimensional point set to obtain a triangular mesh surface; and
determining the triangular mesh surface as a target mesh structure corresponding to the surface effect type.

According to one or more embodiments of this disclosure, the performing a map processing on the target mesh structure to obtain a target effect image comprises:
performing a texture mapping on the three-dimensional mesh surface to obtain a three-dimensional rendered target texture image; and
performing an edge smoothing processing on the three-dimensional rendered target texture image to obtain the target effect image.

According to one or more embodiments of this disclosure, triangulating the whole area contained in the three-dimensional point set to obtain a triangular mesh surface comprises:
determining a center point corresponding to the three-dimensional point set;
constructing a fan surface mesh topology based on the three-dimensional point set and the central point to obtain a three-dimensional topological structure;
converting the boundary value of the three-dimensional topological structure to a calculated value of a percentage coordinate system of the image; and
determining the triangular mesh surface based on the three-dimensional topological structure and a calculated value of each point on the three-dimensional topological structure.

According to one or more embodiments of this disclosure, performing an edge smoothing processing on the three-dimensional rendered target texture image to obtain the target effect image comprises:
rendering each pixel of the three-dimensional rendered target texture image into a rendering texture with each channel value being zero, to obtain a first texture map;
drawing an alpha channel of the first texture map into a grayscale rendering texture to obtain a grayscale mask map;
performing a corrosion processing and a blur processing on the grayscale mask map to obtain a smooth mask map; and
a performing an image fusion processing on the smooth mask map and the first texture map to obtain the target effect image.

According to one or more embodiments of this disclosure, performing a meshing processing on the three-dimensional point set to obtain a target mesh structure comprises:
performing interpolation on pairwise adjacent sampling points in the three-dimensional point set to obtain a target point set;
generating a strip mesh on the contour region corresponding to the target point set to obtain the target mesh structure;
performing a map processing on the target mesh structure to obtain the target effect image comprises:
performing trajectory rendering on the target mesh structure to obtain a three-dimensional strip trajectory map; and
determining the target effect image based on the three-dimensional strip trajectory map.

According to one or more embodiments of this disclosure, the determining the target effect image according to the three-dimensional strip trajectory comprises:
rendering the three-dimensional strip trajectory to a rendering texture with each channel value of zero to obtain a second texture map;
performing edge mixing processing on the three-dimensional strip trajectory based on the second texture map to obtain a trajectory mixing image; and
performing a transparency processing on the trajectory mixing image according to a rendering transparency to obtain the target effect image.

According to one or more embodiments of this disclosure, further comprising:
determining a trigger time of the effect drawing request triggered by the user;
determining a target holiday type corresponding to the trigger time according to a time period corresponding to at least one holiday type; and
obtaining a texture image pre-associated with the target holiday type,
wherein the performing a map processing on the target mesh structure to obtain a target effect image comprises:
performing the map processing on the target mesh structure by using the texture image to obtain the target effect image.

In a second aspect, an apparatus for drawing an effect image is provided according to one or more embodiments of this disclosure, comprising:
a trajectory tracking unit configured to, in response to an effect drawing request triggered by a user, perform trajectory tracking on a target video provided by the user, to obtain a three-dimensional point set corresponding to a motion trajectory of a target object in the target video;
a mesh generation unit configured to perform a meshing processing on the three-dimensional point set to obtain a target mesh structure;
an effect generation unit configured to perform a map processing on the target mesh structure to obtain a target effect image; and
an effect display unit configured to display, in the target video, the target effect image corresponding to the motion trajectory of the target object.

In a third aspect, an electronic device is provided according to one or more embodiments of this disclosure, comprising: a processor, a memory, and an output device;
the memory storing computer executable instructions;
the processor executing the computer executable instructions stored in the memory, to cause the processor to be configured with the method for drawing an effect image according to the first aspect and various possible designs of the first aspect, and the output device being configured to output a target video having a target effect image.

In a fourth aspect, a computer readable storage medium is provided according to one or more embodiments of this disclosure. The computer readable storage medium stores computer executable instructions that, when executed by a processor, implement the method for drawing an effect image according to the first aspect and various possible designs of the first aspect.

In a fifth aspect, a computer program is provided according to one or more embodiments of this disclosure. The computer program that, when executed by a processor, implements the method for drawing an effect image according to the first aspect and various possible designs of the first aspect.

In a sixth aspect, a computer program product is provided according to one or more embodiments of this disclosure. The computer program product, comprising a computer program that, when executed by a processor, implements the method for drawing an effect image according to the first aspect and various possible designs of the first aspect.

The above description is merely an illustration of the preferred embodiments of the present disclosure and the principles of the application. It should be understood by those skilled in the art that the disclosure in the present disclosure is not limited to the technical solutions of the specific combination of the above technical features, and should also cover other technical solutions formed by any combination of the above technical features or their equivalent features without departing from the above disclosed concept. For example, the above features are the technical solutions formed by mutually replacing technical features disclosed in the present disclosure (but not limited to).

Further, while operations are depicted in a particular order, this should not be understood to require that these operations be performed in the particular order shown or in sequential order. In certain circumstances, multitasking and parallel processing may be advantageous. Likewise, while several specific implementation details are included in the discussion above, these should not be construed as limiting the scope of the present disclosure. Certain features described in the context of separate embodiments may also be implemented in combination in a single embodiment. Conversely, the various features described in the context of a single embodiment may also be implemented in multiple embodiments either individually or in any suitable sub-combination.

Although the present subject matter has been described in language specific to structural features and/or methodological acts, it is to be understood that the subject matter defined in the appended claims is not necessarily limited to the specific features or acts described above. Rather, the specific features and acts described above are merely exemplary forms of implementing the claims.

I/We claim:

1. A method for drawing an effect image, comprising:
in response to an effect drawing request triggered by a user, performing trajectory tracking on a target video provided by the user to obtain a three-dimensional point set corresponding to a motion trajectory of a target object in the target video;
performing a meshing processing on the three-dimensional point set to obtain a target mesh structure;
performing a map processing on the target mesh structure to obtain a target effect image; and
displaying, in the target video, the target effect image corresponding to the motion trajectory of the target object.

2. The method of claim 1, wherein the performing trajectory tracking on a target video provided by the user to obtain a three-dimensional target point set corresponding to a motion trajectory of a target object in the target video comprises:
recognizing the target object in the target video;
sampling the motion trajectory of the target object in the target video to obtain at least one target sampling point; and
mapping the at least one target sampling point to a three-dimensional space coordinate system to obtain the three-dimensional point set.

3. The method of claim 2, wherein the sampling the motion trajectory of the target object in the target video to obtain at least one target sampling point comprises:
sampling the motion trajectory of the target object from the target video to obtain a two-dimensional point set, the two-dimensional point set comprising a plurality of first sampling points:
resampling the two-dimensional point set to obtain a plurality of second sampling points; and
determining, from the plurality of second sampling points, at least one target sampling point meeting a trajectory smoothing condition.

4. The method of claim 3, wherein the sampling the motion trajectory of the target object from the target video to obtain a two-dimensional point set comprises:
collecting a trajectory point of the target object from an image frame of the target video according to a predetermined sampling frequency:
determining whether the trajectory point satisfies a distance constraint condition based on a predetermined distance threshold:
if yes, determining a first sampling point based on the trajectory point:
if no, replacing the trajectory point with the last first sampling point in the two-dimensional point set; and
obtaining the two-dimensional point set corresponding to a plurality of first sampling points obtained at the end of collection of the target video.

5. The method of claim 3 or 4, wherein the resampling the two-dimensional point set to obtain a plurality of second sampling points comprises:
performing curve fitting on a plurality of first sampling points in the two-dimensional point set based on a curve fitting algorithm to obtain a first spline:
performing curve fitting on a first first sampling point and a last first sampling point in the two-dimensional point set to obtain a second spline:
obtaining a closed curve by joining the first spline and the second spline; and
resampling the closed curve according to a segmentation interval sampling strategy to obtain the plurality of second sampling points.

6. The method of any of claims 3 to 5, wherein the determining, from the plurality of second sampling points, at least one target sampling point meeting a trajectory smoothing condition comprises:
combining two adjacent sampling points in the plurality of second sampling points to obtain at least one group of sampling points:
determining a dot product result corresponding to two second sampling points in each group of sampling points, the dot product result being obtained by computing a dot product of tangent vectors of two second sampling points:
for the at least one group of sampling points, in response to the dot product result corresponding to the two second sampling points in a target group being less than zero, determining any one of the two second sampling points in the target group as the target sampling point:
in response to the dot product result corresponding to the two second sampling points of the target group being greater than or equal to zero, determining that the two second sampling points in the target group are both the target sampling points; and
obtaining all target sampling points corresponding to the at least one group of sampling points as the at least one target sampling point.

7. The method of any of claims 1 to 6, wherein the performing a meshing processing on the three-dimensional point set to obtain a target mesh structure comprises:
triangulating the whole area contained in the three-dimensional point set to obtain a triangular mesh surface; and
determining the triangular mesh surface as a target mesh structure corresponding to the surface effect type; and
wherein the performing a map processing on the target mesh structure to obtain a target effect image comprises:
performing a texture mapping on the three-dimensional mesh surface to obtain a three-dimensional rendered target texture image; and
performing an edge smoothing processing on the three-dimensional rendered target texture image to obtain the target effect image.

8. The method of claim 7, wherein the triangulating the whole area contained in the three-dimensional point set to obtain a triangular mesh surface comprises:
determining a center point corresponding to the three-dimensional point set:
constructing a fan surface mesh topology based on the three-dimensional point set and the central point to obtain a three-dimensional topological structure;
converting the boundary value of the three-dimensional topological structure to a calculated value of a percentage coordinate system of an image; and
determining the triangular mesh surface based on the three-dimensional topological structure and a calculated value of each point on the three-dimensional topological structure.

9. The method of claim 7 or 8, wherein the performing edge smoothing processing on the three-dimensional rendered target texture image to obtain the target effect image comprises:
rendering each pixel of the three-dimensional rendered target texture image into a rendering texture with each channel value being zero, to obtain a first texture map:
drawing an alpha channel of the first texture map into a grayscale rendering texture to obtain a grayscale mask map:
performing a corrosion processing and a blur processing on the grayscale mask map to obtain a smooth mask map; and
performing an image fusion processing on the smooth mask map and the first texture map to obtain the target effect image.

10. The method of any of claims 1 to 6, wherein the performing a meshing processing on the three-dimensional point set to obtain a target mesh structure comprises:
performing interpolation on pairwise adjacent sampling points in the three-dimensional point set to obtain a target point set:
generating a strip mesh on the contour region corresponding to the target point set to obtain the target mesh structure;
performing a map processing on the target mesh structure to obtain the target effect image comprises:
performing trajectory rendering on the target mesh structure to obtain a three-dimensional strip trajectory map; and
determining the target effect image based on the three-dimensional strip trajectory map.

11. The method of claim 10, wherein the determining the target effect image according to the three-dimensional strip trajectory comprises:
rendering the three-dimensional strip trajectory to a rendering texture with each channel value of zero to obtain a second texture map; and
performing a transparency processing on the second texture map according to a rendering transparency to obtain the target effect image.

12. The method of any of claims 1 to 11, further comprising:
determining a trigger time of the effect drawing request triggered by the user:
determining a target holiday type corresponding to the trigger time according to a time period corresponding to at least one holiday type; and
obtaining a texture image pre-associated with the target holiday type,
wherein the performing a map processing on the target mesh structure to obtain a target effect image comprises:
performing the map processing on the target mesh structure by using the texture image to obtain the target effect image.

13. An apparatus for drawing an effect image, comprising:
a trajectory tracking unit configured to, in response to an effect drawing request triggered by a user, perform trajectory tracking on a target video provided by the user, to obtain a three-dimensional point set corresponding to a motion trajectory of a target object in the target video;
a mesh generation unit configured to perform a meshing processing on the three-dimensional point set to obtain a target mesh structure;
an effect generation unit configured to perform a map processing on the target mesh structure to obtain a target effect image; and
an effect display unit configured to display, in the target video, the target effect image corresponding to the motion trajectory of the target object.

14. An electronic device, comprising: a processor, a memory, and an output device:
the memory storing computer executable instructions:
the processor executing the computer executable instructions stored in the memory, to cause the processor to be configured with the method for drawing an effect image according to any of claims 1 to 12, and
the output device being configured to output a target video having a target effect image.

15. A computer readable storage medium storing computer executable instructions that, when executed by a processor, implement the method for drawing an effect image according to any of claims 1 to 12.

16. A computer program, comprising a computer program that, when executed by a processor, implements the method for drawing an effect image according to any of claims 1 to 12.

17. A computer program product, comprising a computer program that, when executed by a processor, implements the method for drawing an effect image according to any of claims 1 to 12.
